(19) United States
(12) Patent Application Publication
(10) Pub. No.: US 2014/0081901 A1
(43) Pub. Date: Mar. 20, 2014

(54) SHARING MODELING DATA BETWEEN PLUG-IN APPLICATIONS

(71) Applicant: Martin Szymczak, Scottsdale, AZ (US)

(72) Inventor: Martin Szymczak, Scottsdale, AZ (US)

(73) Assignee: NetApp, Inc., Sunnyvale, CA (US)

(21) Appl. No.: 12/429,731

(22) Filed: Apr. 24, 2009

(51) Int. Cl. G06F 17/30; G06F 12/00; G06F 9/44

(52) U.S. Cl. 707/601; 719/328; 711/102; 711/104; 707/E17.006; 707/750; 707/781

(57) ABSTRACT

Embodiments of the present invention provide various techniques for sharing modeling data between plug-in applications. The plug-in applications may use or generate various modeling data. In an example, the host application that interfaces with the plug-in applications can access and store this modeling data at a location where it is accessible to the other plug-in applications.

### COPYRIGHT

A portion of the disclosure of this document may include material that is subject to copyright protection. The copyright owner has no objection to the facsimile reproduction by anyone, of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document. Copyright©2009, NetApp. All Rights Reserved.

### FIELD

The present disclosure relates generally to computer modeling. In an example embodiment, the disclosure relates to sharing modeling data between plug-in applications.

### BACKGROUND

A storage system can be a complex system with numerous software and hardware components, such as network pipes, caches, storage servers, switches, storage controllers, and other components. In modeling a storage system, a variety of plug-in applications may be used to model various components of the storage system. For example, one type of plug-in application can function to simulate one or more components associated with a storage system, such as storage servers, storage controllers, client computers, hard disk drives, and optical disk drives. These plug-in applications are typically developed by different software developers and therefore, usually cannot communicate with each other. In examples where a plug-in application is programmed to directly communicate with another plug-in application, the software developers of the plug-in applications need to coordinate with each other to make the plug-in applications compatible with each other.

This coordination between the software developers can be very labor-intensive and complicated given the large number of software developers and plug-in applications. For example, if a software developer updates its plug-in application, then this software developer needs to identify and coordinate with all the other software developers to also update their plug-in applications such that the plug-in applications are communicatively compatible with the updated plug-in application.

### SUMMARY

Examples of the present invention provide various techniques for sharing data between plug-in applications used in modeling a storage system by a host application managing data for the plug-in applications. The plug-in applications are configured to interface with a host application that, for example, builds models of the storage system. In various embodiments of the invention, the host application that interfaces with the plug-in applications can access and store, for example, modeling data at a location where it is accessible to other plug-in applications. For example, the host application that receives modeling data from one plug-in application may store the modeling data as a file on a disk. When another plug-in application is loaded, the host application may provide the stored modeling data to this other plug-in application for use in, for example, providing certain functionalities associated with modeling the storage system.

As a result of being able to share modeling data between plug-in applications through the use of a host application, the plug-in applications do not need to be specifically programmed to communicate with each other. Rather, the plug-in applications can share modeling data with each other by simply communicating or interfacing with the host application. Furthermore, the software developers that make the plug-in applications may not need to coordinate with each other to make the plug-in applications communicatively compatible. In addition, the plug-in applications may be used or executed more efficiently by eliminating input of redundant modeling data. For example, a particular plug-in application may need for its functionality modeling parameters used by another plug-in application. Instead of manually reentering the same modeling parameters, the host application has already saved the modeling parameters and can therefore provide the saved modeling data to the plug-in application when needed.

### BRIEF DESCRIPTION OF DRAWINGS

The present disclosure is illustrated by way of example and not limitation in the figures of the accompanying drawings, in which like references indicate similar elements and in which:

FIGS. 1A and 1B depict block diagrams illustrating the sharing of modeling data between multiple plug-in applications, consistent with an embodiment of the present invention;

FIG. 2 depicts a block diagram of the various modules associated with the host application, in accordance with an embodiment, included in a processing system;

FIG. 3 depicts a flow diagram of a general overview of a method, in accordance with an embodiment of the present invention, for providing plug-in applications with access to modeling data;

FIG. 4 depicts a diagram of a schema of a set of records, consistent with an embodiment of the invention, for use in organizing and storing modeling data;

FIG. 5 depicts a flow diagram of a general overview of a method, in accordance with an embodiment, for saving modeling data;

FIG. 6 depicts a diagram of an example of a document that includes the schema with modeling data;

FIG. 7 depicts a flow diagram of a detailed method, in consistent with an embodiment of the invention, for accessing and storing modeling data; and

FIG. 8 depicts a block diagram of a machine in the example form of a processing system within which a set of instructions, for causing the machine to perform any one or more of the methodologies discussed herein, may be executed.

### DESCRIPTION OF EXAMPLE EMBODIMENTS

The description that follows includes illustrative systems, methods, techniques, instruction sequences, and computing machine program products that embody embodiments of the present invention. In the following description, for purposes of explanation, numerous specific details are set forth in order to provide an understanding of various embodiments of the inventive subject matter. It will be evident, however, to one skilled in the art that embodiments of the inventive subject matter may be practiced without these specific details. In general, well-known instruction instances, protocols, structures and techniques have not been shown in detail.

A computer model is a computer program that can be programmed to simulate a variety of systems, such as computer systems. In an example, a computer model can be used to predict mathematically the behavior of a system without access to the actual system that is being simulated. In effect, a computer model is actually a mathematical model carried out by a computing device, such as a computer. The mathematical model may be constructed to find analytical solutions to various types of problems, such as prediction of the behavior of a storage system. As explained in more detail below, a “storage system,” generally refers to a system of processing systems and storage devices where data is stored on the storage devices such that the data can be made available to a variety of processing systems on a computer network. A computer model of the storage system may be constructed, and this computer model uses a mathematical model of the storage system to mathematically analyze and/or simulate the storage system. Such simulation may be used to facilitate the design and management of storage systems by allowing a user, for example, to assess and/or test impacts of simulated workloads on computer models of the storage systems.

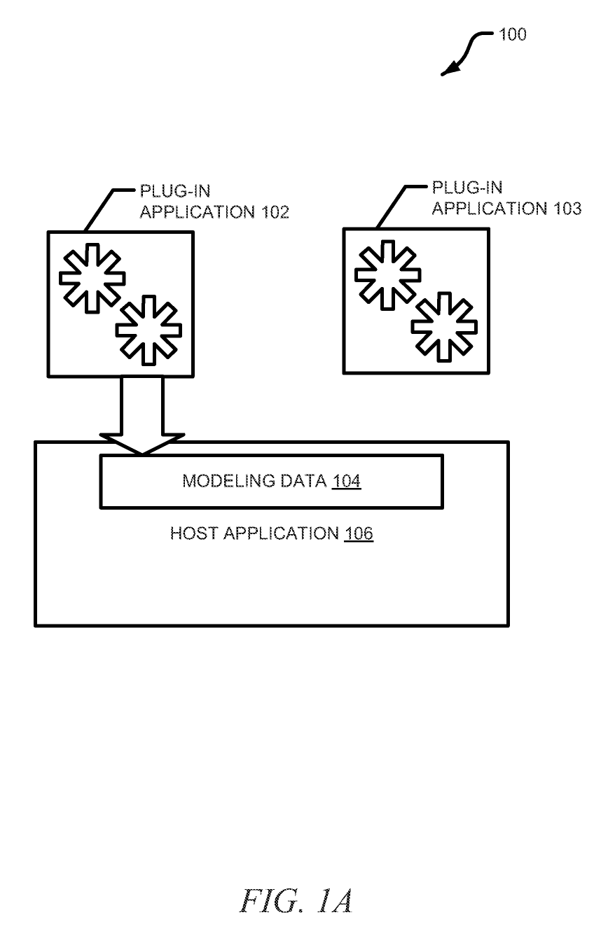

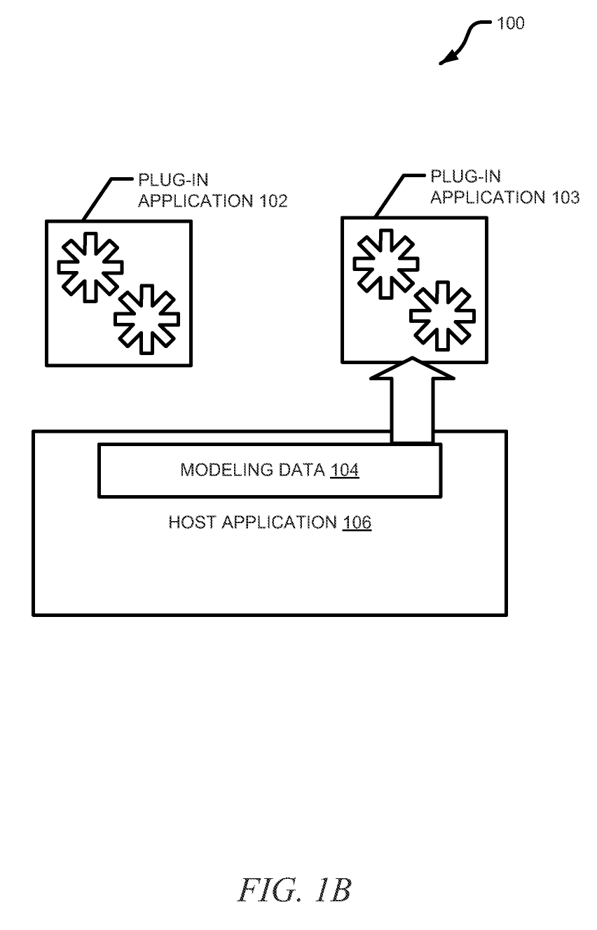

FIGS. 1A and 1B depict block diagrams illustrating the sharing of modeling data between multiple plug-in applications, consistent with an embodiment of the present invention. As depicted in FIG. 1A, the system 100 includes two plug-in applications 102 and 103 that can interface with a host application 106. The host application 106 is a standalone application that is configured to load or interface with plug-in applications 102 and 103, and may provide a variety of functionalities associated with modeling a storage system. For example, the host application 106 may provide a series of modeling and visualization tools that are used to assist with provisioning a storage system. In another example, the host application 106 is configured to model the storage system by building models of the storage system and present various aspect of a storage deployment. It should be appreciated that to “load” a plug-in application 102 or 103 is to bring the plug-in application 102 or 103 into main memory.

A “plug-in application,” such as plug-in application 102 or 103, refers to a software program that interfaces with the host application 106, for example, to extend, modify, and/or enhance the capabilities or functionalities of the host application 106. The plug-in applications 102 and 103 effectively depend on the host application 106 and may not function independently without the host application 106. In the embodiment of FIGS. 1A and 1B, the plug-in applications 102 and 103 may be configured to provide additional functionalities associated with modeling a storage system. For example, a plug-in application 102 or 103 may be configured to calculate or generate various data about the storage system, such as storage capacity, network traffic rate, and other data. In another example, a plug-in application 102 or 103 may provide additional tools, such as tools for building charts, tools for building administrative functions (e.g., check for software updates and adding license keys), and other tools. In yet another example, a plug-in application 102 or 103 is configured to model a hardware component, a software component, and/or services associated with a storage system. Hardware components that may be modeled by the plug-in applications 102 and 103 include, for example, storage servers, storage controllers, client computers, hard disk drives, optical disk drives, processors, random access memories, non-volatile memories, tape drives, controllers (e.g., Redundant Array of Independent Disks (RAID) controllers), switches (e.g., Fibre Channel switches), adaptors (e.g., Storage Area Network (SAN) adaptors, Computer System Interface (SCSI) tape adaptors, network adaptors, and other adaptors), power supplies, and other hardware components. The software components that may be modeled by the plug-in applications 102 and 103 include, for example, data replication software, data classification and management software, device drivers, databases, volume managers, file systems, multipathing software, backup and recovery software, antivirus software, networking software, data security or protection software, data search engines, file storage resource management software, data retention software, and other software components.

In this example, the plug-in applications 102 and 103 may be developed by different third-party developers and therefore, are not configured to communicate directly with each other. As a result, for example, the plug-in application 102 cannot directly communicate with plug-in application 103, for example, to share data. Instead, in an embodiment of the invention, the plug-in application 102 can share data, such as modeling data 104, with the plug-in application 103 by way of the host application 106. As used herein, the “modeling data,” such as modeling data 104, refers to a variety of data associated with modeling the storage system. For example, the modeling data 104 may include one or more modeling parameters, which are variables that are given specific values during the execution of a plug-in application 102 or 103. In another example, the modeling data 104 may include one or more modeling results, which are data generated as a consequence of execution of a plug-in application 102 or 103.

The host application 106 is configured to store and share the modeling data 104 with loaded plug-in applications 102 and/or 103. For example, as depicted in FIG. 1A, the host application 106 receives modeling data 104 from plug-in application 102. As depicted in FIG. 1B, the host application 106 may then share or provide this modeling data 104 to the plug-in application 103. As a result, the plug-in application 103 can, for example, reuse the modeling data 104 generated by or used in plug-in application 102. The ability to share the modeling data 104 between plug-in applications 102 and 103 may, in one example, increase the speed and efficiency of the execution of the plug-in application 103 because it does not need to recalculate the same modeling data 104. Furthermore, the plug-in applications 102 and 103 do not need to be specifically programmed to communicate with each other, which may become problematic if the plug-in applications 102 and 103 are developed by different third-party developers. In the embodiment depicted in FIGS. 1A and 1B, the plug-in applications 102 and 103 just need to be configured to interface with the host application 106 to be able to share the modeling data 104.

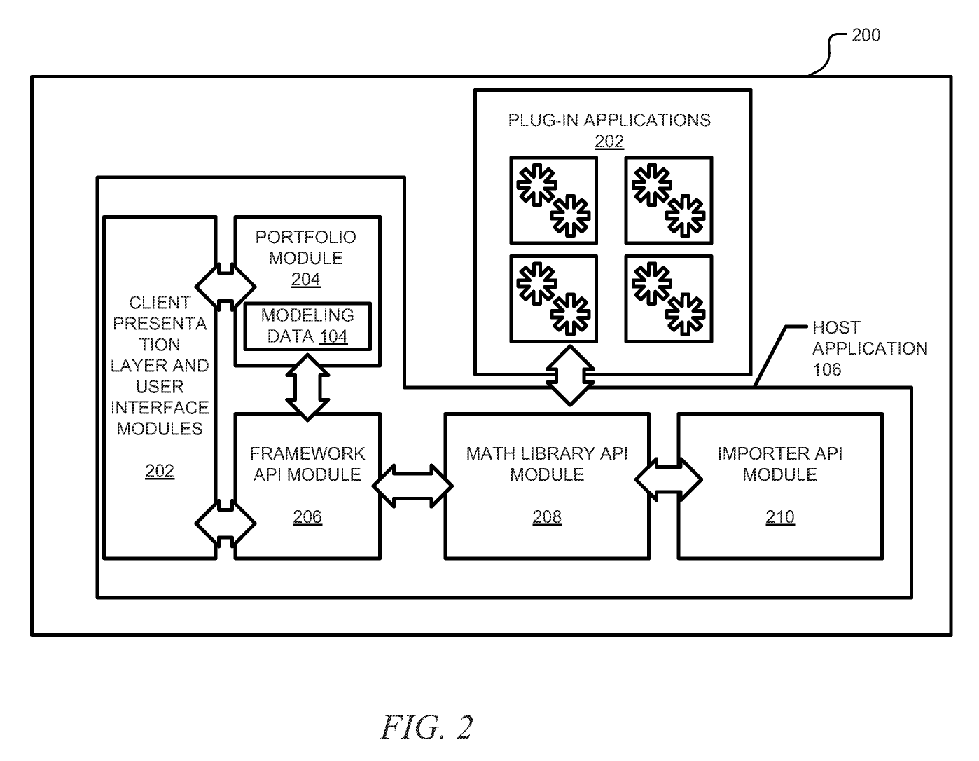

FIG. 2 depicts a block diagram of the various modules associated with the host application 106, in accordance with an embodiment, included in a processing system 200. It should be appreciated that the processing system 200 may be deployed in the form of a variety of computing devices, such as personal computers, personal digital assistants, laptops computers, and server computers. The processing system 200 may be included in a storage system and, as described in more detail below, the processing system 200 may be used to implement various computer programs, logic, applications, methods, and/or processes to share modeling data 104.

The host application 106 is configured to interface with various plug-in applications 202. In an embodiment, as depicted in FIG. 2, the host application 106 includes client presentation layer and user interface modules 202, a portfolio module 204, a framework application programming interface (API) module 206, a math library API module 208, and an importer API module 210. As discussed above, the host application 106 is configured to provide various functionalities associated with modeling a storage system. The storage system can be deployed within, for example, a Storage Area Network (SAN) and/or a Network Attached Storage (NAS) environment.

A SAN is a high-speed network that enables establishment of direct connections between the storage systems and their storage devices. The SAN may thus be viewed as an extension to a storage bus and, as such, operating systems of the storage systems enable access to stored data using block-based access protocols over an extended bus. In this context, the extended bus can be embodied as Fibre Channel, Computer System Interface (SCSI), Internet SCSI (iSCSI) or other network technologies.

When used within a NAS environment, for example, the storage system may be embodied as file servers that are configured to operate according to a client/server model of information delivery to thereby allow multiple client processing systems, such as client processing system, to access shared resources, such as data and backup copy of the data, stored on the file servers. The storage of information on a NAS environment can be deployed over a computer network that includes a geographically distributed collection on interconnected communication links, such as Ethernet, that allows the client processing systems to access remotely the information or data on the file servers. The client processing systems can communicate with one or more file servers by exchanging discrete frames or packets of data according to predefined protocols, such as Transmission Control/Internet Protocol (TCP/IP).

The framework API module 206 generally provides some modeling tools and handles communication between various modules. As one of its functions, the framework API module 206 is configured to communicate and interface with the plug-in applications 202. Interfacing with the plug-in applications 202 includes, for example, loading the plug-in applications 202 and processing requests from the plug-in applications 202, such as requests to access and save the modeling data 104 in the portfolio module 204. The portfolio module 204 is a collection of projects where the modeling data 104 may be saved or stored. It should be noted that the modeling data 104 included in the portfolio module 204 is stored or saved in a nonvolatile memory, such as hard drives, tape drives, and flash memories.

The math library API module 208 primarily provides a repository of math functions to the plug-in applications 202. However, in the embodiment of FIG. 2, the math library API module 208 may also provide a set of records that the plug-in applications 202 may directly access to store their modeling data 104. As used herein, a “record” refers to one or more related fields treated as a unit and comprising part of, for example, a file or data set, for purposes of input, processing, output, and/or storage by a processing system. The math library API module 208 may present these set of records to the plug-in applications 202 in volatile memory. The plug-in applications 202 may then temporarily store newly generated modeling data 104 in the set of records or update existing modeling data 104 in the set of records while in volatile memory until the modeling data 104 is specifically “saved” to the portfolio module 204, which, as discussed above, stores the modeling data 104 from the volatile memory onto a location of the nonvolatile memory assigned to the portfolio module 204.

Still referring to FIG. 2, the importer API module 210 is configured to identify and import various components from different storage systems. The client presentation layer and user interface modules 202 are configured to render and display various graphical interfaces for use in interfacing with the host application 106. For example, in an embodiment, the client presentation layer and user interface modules 202 are configured to receive data from the plug-in applications 202. This data may, for example, result from the execution of the plug-in applications 202 based on the modeling data 104. For example, this data can represent a functionality associated with modeling the storage system. The client presentation layer and user interface modules 202 may then display the data at a video display unit in the form of, for example, a graphical user interface.

It should be appreciated that in other embodiments, the processing system 200 may include fewer or more modules apart from those shown in FIG. 2. For example, the framework API module 206 and the math library API module 208 may be integrated into one module. The modules 202, 204, 206, 208, and 210 may be in the form of software that is processed by at least one processor. In another example, the modules 202, 204, 206, 208, and 210 may be in the form of firmware that is processed by, for example, application specific integrated circuits (ASICs), which may be integrated into a circuit board. Alternatively, the modules 202, 204, 206, 208, and 210 may be in the form of one or more logic blocks included in a programmable logic device (e.g., a field programmable gate array). The described modules 202, 204, 206, 208, and 210 may be adapted and/or additional structures may be provided, to provide alternative or additional functionalities beyond those specifically discussed in reference to FIG. 2. Examples of such alternative or additional functionalities will be discussed in reference to the flow diagrams discussed below. The modifications or additions to the structures described in relation to FIG. 2 to implement these alternative or additional functionalities will be implementable by those skilled in the art, having the benefit of the present specification and teachings.

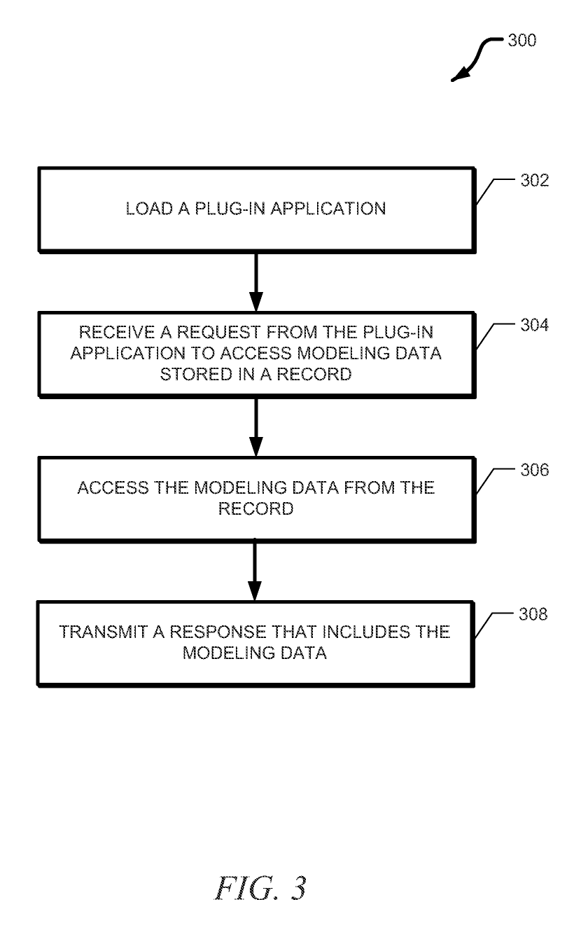

FIG. 3 depicts a flow diagram of a general overview of a method 300, in accordance with an embodiment of the present invention, for providing plug-in applications with access to modeling data. In an embodiment, the method 300 may be implemented by the host application 106 and employed in the processing system 200 of FIG. 2. As depicted in FIG. 3, a plug-in application is loaded at 302, and a request from the plug-in application is received at 304 to access modeling data stored in a set of records, which is previously provided by another plug-in application.

This received request, in accordance with an embodiment, includes at least one name of a record. An example of a name for a record is “com.netapp.sepo.synergy.ModelPortability.” Another example of a name for a record is “controller.StorageSystemID.” Upon receipt of the request, the modeling data is accessed from the set of records at 306. The access may include, for example, locating a record from the set of records based on the name of the record and then retrieving the modeling data from the located record. After the modeling data has been accessed, a response to the request is transmitted at 308, and this response includes the requested modeling data.

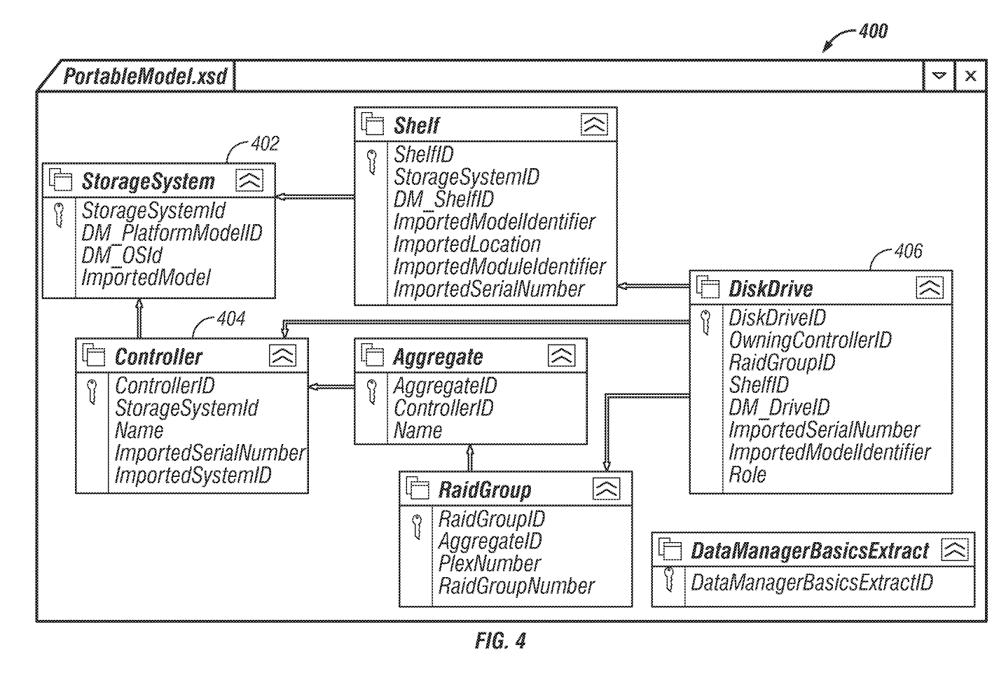

FIG. 4 depicts a diagram of a schema 400 of a set of records, consistent with an embodiment of the invention, for use in organizing and storing modeling data. A “schema,” as used herein, refers to a structure of a collection of records. In one example, as depicted in FIG. 4, the schema may be a database structure. In a relational database, the schema 400 defines the tables, the fields in each table, and the relationships between fields and tables. As depicted, the schema 400 defines a set of records organized in tables, and the lines connecting the tables illustrate the relationships between the tables. Each table is configured to store modeling data associated with a particular attribute of the storage system. For example, the table 402 named “StorageSystem” is configured to store modeling data associated with one or more storage systems. The table 404 named “Controller” is configured to store modeling data associated with storage controllers used in the storage system. Additionally, the table 406 named “DiskDrive” is configured to store various modeling data associated with one or more disk drives in the storage system.

In an embodiment, the schema 400 is predefined. That is, the schema of records is laid out or defined beforehand and all the plug-in applications interface with or access an identical schema 400. As explained previously, the math library API module, for example, may provide this schema 400 to the plug-in applications through its API. In addition to accessing the modeling data based on the schema 400, the plug-in applications, as explained in more detail below, may also use this schema 400 for storing its modeling data temporarily in volatile memory until the modeling data is subsequently saved.

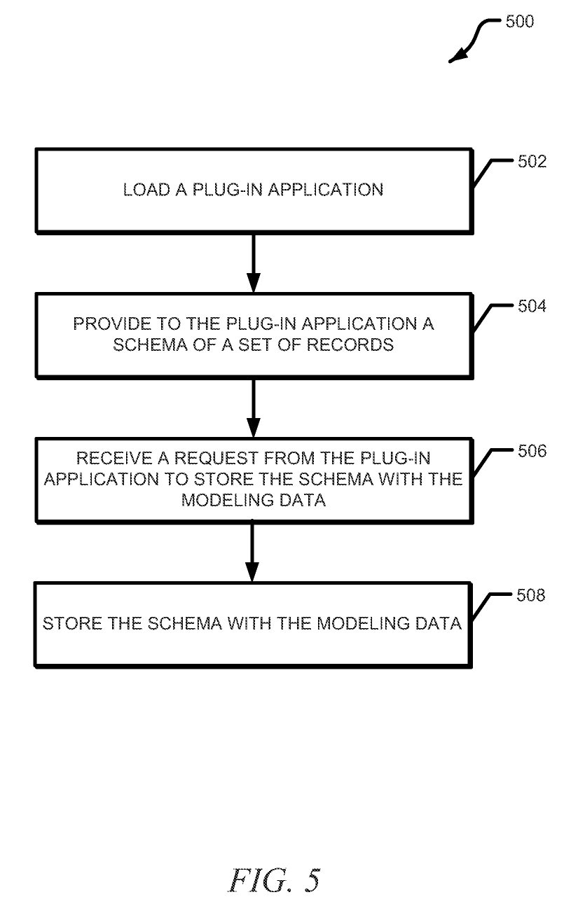

FIG. 5 depicts a flow diagram of a general overview of a method 500, in accordance with an embodiment, for saving modeling data. In an embodiment, the method 500 may be implemented by the host application 106 and employed in the processing system 200 of FIG. 2. As depicted in FIG. 5, a plug-in application is loaded at 502 and a schema of a set of records is provided to this plug-in application at 504. In an embodiment, the schema may be provided to the plug-in application by exposing it through an API, such as through the math library API.

The schema of records may be loaded temporarily in volatile memory where the plug-in application may write modeling data to the records based on the schema. In effect, a scratch pad of the schema is provided to the plug-in application in volatile memory for use as a temporary storage of, for example, preliminary modeling data generated by the plug-in application. When a decision is made to save the modeling data, the plug-in application transmits a request to store this schema with the modeling data. This request is received at 506 and upon receipt of the request, the schema with the modeling data is then stored in, for example, nonvolatile memory where it can be made accessible to or shared with other plug-in applications.

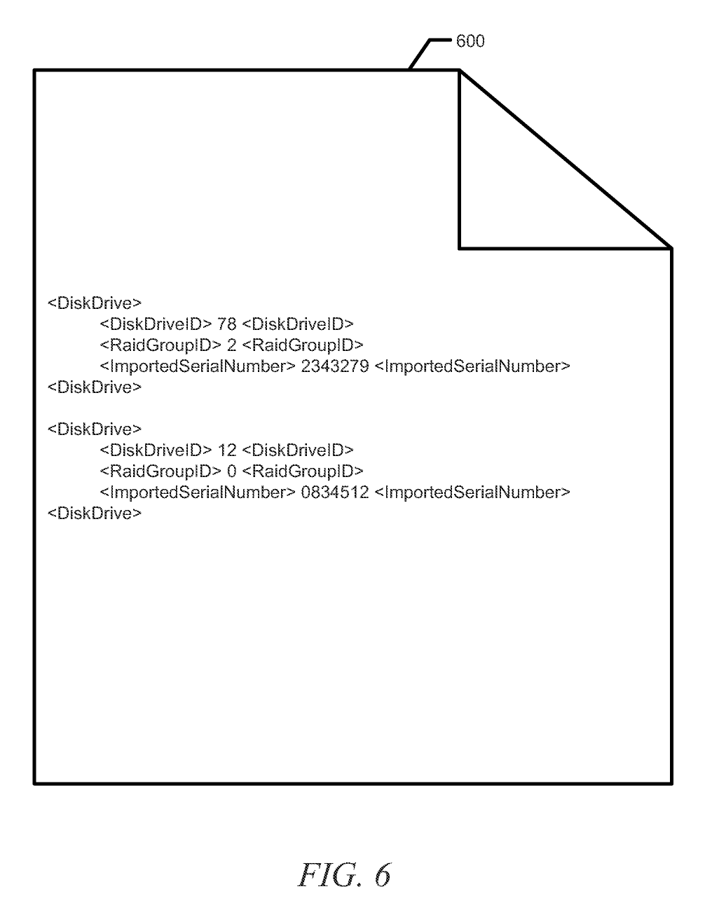

In an embodiment, the schema of modeling data may be saved to or included in a document. FIG. 6 depicts a diagram of an example of a document 600 that includes the schema with modeling data. As used herein, a “document” refers to electronic media content that is accessible by computer technology. For example, the document 600 can be a file that is not an executable file or a system file and includes data for use by a computer program. Examples of document 600 include a single or multiple files that are accessible by and/or associated with electronic document processing applications such as word processing applications, document viewers, email applications, presentation applications, spreadsheet applications, diagramming applications, graphic editors, graphic viewers, enterprise applications, and other applications. Therefore, the document 600 may be composed of alphanumeric texts, symbols, images, videos, sounds, and other data.

As depicted in FIG. 6, in an embodiment, the document 600 is an eXtensible Markup Language (XML) document. Here, the schema with the modeling data is converted into an XML format. For example, the conversion may include assigning tags based on the schema to each record defined in the schema. After the conversion, the schema with the modeling data is stored in the XML document 600. It should be noted that an XML document can be used to store modeling data because XML is an extensible language that is inherently hierarchical where, for example, the modeling data can be stored with its hierarchical structure based on the schema. Furthermore, the document 600, particularly in XML, is portable where it can be copied to and used on, for example, different host applications.

In other embodiments, it should be appreciated that the schema with the modeling data may also be saved to or included in a variety of other data structures. In general, a “data structure,” as used herein, provides context for the organization of data. Examples of data structures include tables, arrays, linked lists, databases, and other data structures.

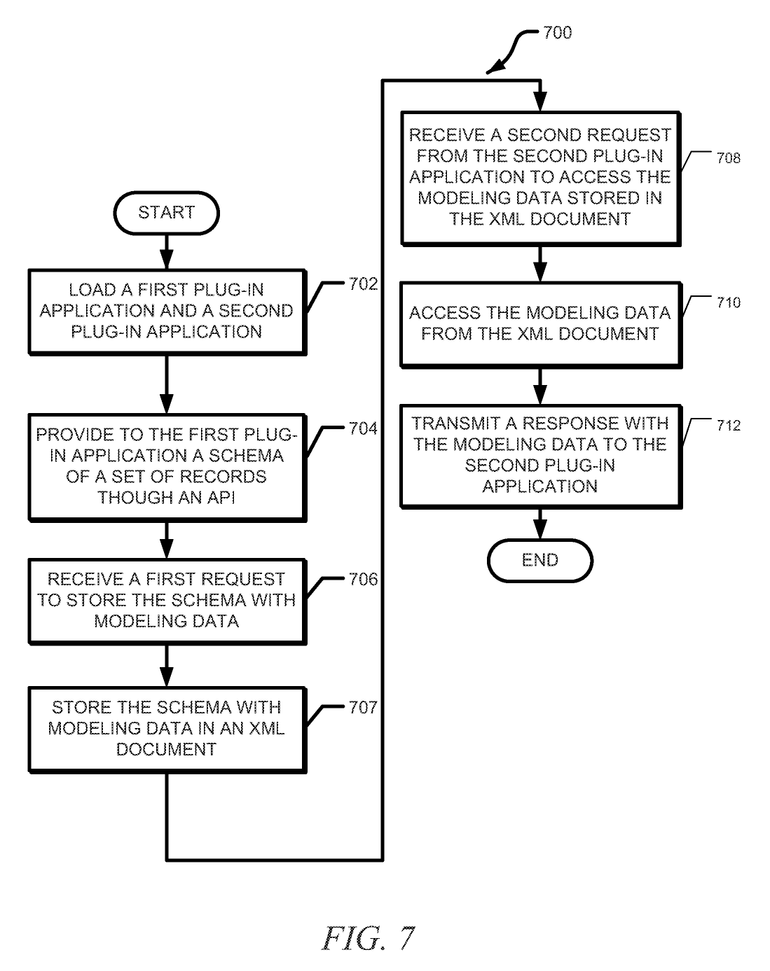

FIG. 7 depicts a flow diagram of a detailed method 700, consistent with an embodiment of the invention, for accessing and storing modeling data. In this example, a framework API module loads two plug-in applications at 702, namely a “first” plug-in application and a “second” plug-in application. In this embodiment, a math library API module provides a schema of a set of records to the first plug-in application at 704. As discussed above, this schema of records can be provided in volatile memory where the first plug-in application may store its modeling data temporarily based on the provided schema until it is saved.

The framework API module may then receive a “first” request from the first plug-in application to save the schema with the modeling data at 706 in the nonvolatile memory such that the modeling data may be shared with other plug-in applications, such as the second plug-in application. Upon receipt of the first request, the framework API module may save the schema with the modeling data in, for example, an XML document on a disk drive at 707.

After the modeling data from the first plug-in application is saved, the framework API module may receive a second request from the second plug-in application to access the modeling data stored in the XML document. Here, the second plug-in application may, for example, need to reuse the modeling parameters used by the first plug-in application such that the second plug-in application can, for example, model a different functionality of the storage system based on the same modeling parameters used by the first plug-in application. As a result, a user, for example, will therefore not need to input manually the same modeling parameters used by the first plug-in application again for use with the second plug-in application.

As depicted at 710, upon receipt of the second request from the second plug-in application, the framework API module then accesses the requested modeling data from the XML document and, at 712, then transmits the requested modeling data to the second plug-in application in a response to the request.

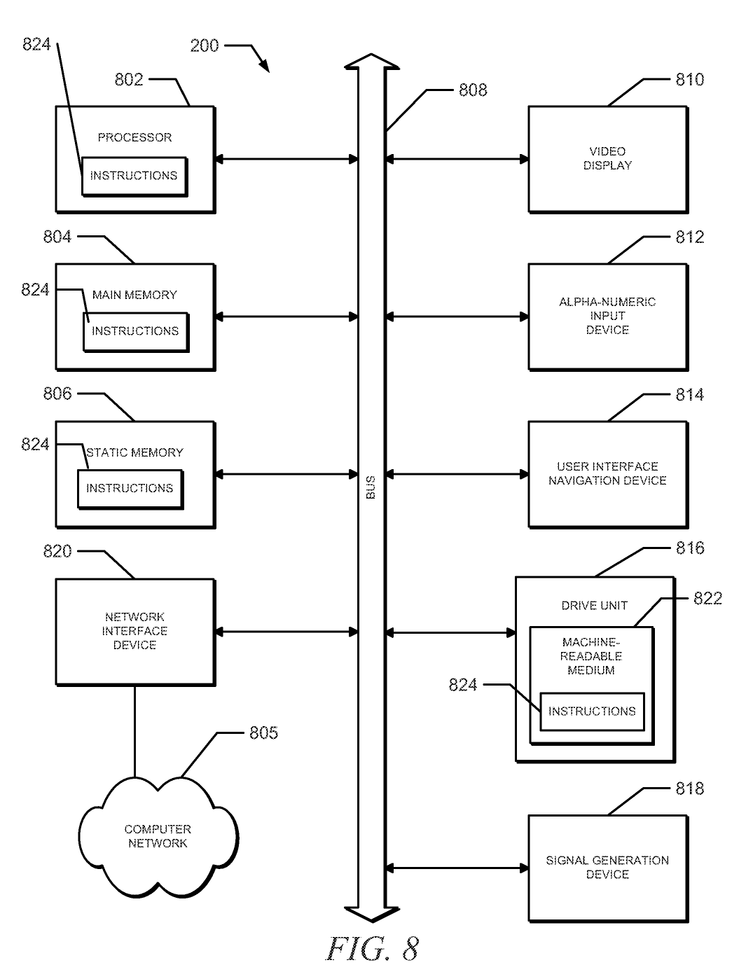

FIG. 8 depicts a block diagram of a machine in the example form of a processing system 200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Embodiments may also, for example, be deployed by Software-as-a-Service (SaaS), Application Service Provider (ASP), or utility computing providers, in addition to being sold or licensed via traditional channels.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 200 includes a processor 802 (e.g., a central processing unit (CPU), a graphics processing unit (GPU) or both), a main memory 804 (e.g., random access memory (a type of volatile memory)), and static memory 806 (e.g., static random access memory (a type of volatile memory)), which communicate with each other via bus 808. The processing system 200 may further include video display unit 810 (e.g., a plasma display, a liquid crystal display (LCD) or a cathode ray tube (CRT)). The processing system 200 also includes an alphanumeric input device 812 (e.g., a keyboard), a user interface (UI) navigation device 814 (e.g., a mouse), a disk drive unit 816, a signal generation device 818 (e.g., a speaker), and a network interface device 820.

The disk drive unit 816 (a type of non-volatile memory storage) includes a machine-readable medium 822 on which is stored one or more sets of instructions and data structures 824 (e.g., software) embodying or utilized by any one or more of the methodologies or functions described herein. The instructions and data structures 824 may also reside, completely or at least partially, within the main memory 804 and/or within the processor 802 during execution thereof by processing system 200, with the main memory 804 and processor 802 also constituting machine-readable, tangible media.

The instructions and data structures 824 may further be transmitted or received over a computer network 805 via network interface device 820 utilizing any one of a number of well-known transfer protocols (e.g., HTTP).

While the embodiment(s) is (are) described with reference to various implementations and exploitations, it will be understood that these embodiments are illustrative and that the scope of the embodiment(s) is not limited to them. In general, techniques for sharing modeling data may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

1. A method of sharing modeling data between a plurality of plug-in applications, the method comprising:
loading a first plug-in application from the plurality of plug-in applications, each plug-in application being configured to model a component of a storage system that comprises processing systems and storage devices;
receiving a request from the first plug-in application to access modeling data stored in a record, the modeling data being associated with the modeling of the storage system and being previously provided by a second plug-in application from the plurality of plug-in applications, wherein the first and second plug-in applications do not communicate directly with each other;
accessing the modeling data from the record; and
transmitting a response to the first plug-in application, the response including the modeling data.

2. The method of claim 1, wherein the request includes a name of the record, the accessing of the modeling data comprises:
locating the record based on the name of the record; and
retrieving the modeling data from the record.

3. The method of claim 1, further comprising:
receiving data from the first plug-in application based on an execution of the plug-in application using the modeling data, the data representing a functionality associated with modeling the storage system; and
displaying the data at a video display unit.

4. The method of claim 1, wherein the record is included in a data structure.

5. The method of claim 1, wherein the record is included in a document.

6. The method of claim 1, wherein the plurality of plug-in applications is configured to interface with a host application that is configured to model the storage system.

7. The method of claim 1, wherein the first plug-in application is configured to model a hardware component of the storage system.

8. A processing system, comprising:
at least one processor; and
a non-transitory, machine-readable medium in communication with the at least one processor, the non-transitory, machine-readable medium storing a framework application programming interface (API) module and a math library API module that are executable by the at least one processor, the framework API module and the math library API module being executed by the at least one processor to cause operations to be performed, comprising:
loading a first plug-in application from a plurality of plug-in applications, each plug-in application being configured to model a component of a storage system that comprises processing systems and storage devices;
providing to the first plug-in application a schema of a set of a plurality of records, the first plug-in application configured to store modeling data in the schema of the set of the plurality of records;
receiving a request from the first plug-in application to store the schema with the modeling data; and
storing the schema with the modeling data, the schema with the modeling data being accessible by at least one other plug-in application from the plurality of plug-in applications, wherein the first and second plug-in applications do not communicate directly with each other.

9. The processing system of claim 8, wherein the operation of providing to the first plug-in application the schema comprises exposing the schema to the plug-in application through the math library API module.

10. The processing system of claim 8, wherein the operations further comprise converting the schema with the modeling data into an extensible markup language (XML) format, wherein the schema with the modeling data is stored in an XML document.

11. The processing system of claim 8, wherein the non-transitory, machine-readable medium includes a non-volatile memory, and wherein the schema is stored in the non-volatile memory.

12. The processing system of claim 8, wherein the schema is a database structure.

13. A processing system, comprising:
at least one processor; and
a non-transitory, machine-readable medium in communication with the at least one processor, the non-transitory, machine-readable medium storing a schema of a set of a plurality of records, the non-transitory, machine-readable medium further storing a framework application programming interface (API) module that is executable by the at least one processor, the framework API module being executed by the at least one processor to cause operations to be performed, comprising:
loading a first plug-in application from a plurality of plug-in applications, each plug-in application being configured to model a component of a storage system that comprises processing systems and storage devices;
receiving a request from the first plug-in application to access modeling data stored in a schema of a set of a plurality of records, the modeling data being previously provided by a second plug-in application from the plurality of plug-in applications,
wherein the first and second plug-in applications do not communicate directly with each other;
accessing the modeling data from the schema of the set of plurality of records; and
transmitting a response to first the plug-in application, the response including the modeling data.

14. The processing system of claim 13, wherein the non-transitory, machine-readable medium further stores a math library API module that is executable by the at least one processor,
the math library API module being executed by the at least one processor to cause operations to be performed, comprising providing to the first plug-in application the schema of the set of the plurality of records, the plug-in application configured to store additional modeling data in the schema of the set of the plurality of records,
the framework API module being executed by the at least one processor to cause further operations to be performed, comprising:
receiving a further request from the first plug-in application to store the schema with the additional modeling data; and
storing the schema with the additional modeling data, the schema with the additional modeling data being accessible by the second plug-in application from the plurality of plug-in applications.

15. The processing system of claim 14, wherein the non-transitory, machine-readable medium includes a volatile memory, wherein the schema is provided to the first plug-in application in the volatile memory.

16. The processing system of claim 14, wherein the non-transitory, machine-readable medium includes a non-volatile memory, wherein the schema with the additional modeling data is stored in the non-volatile memory.

17. The processing system of claim 13, wherein the framework API module is configured to interface with the plurality of plug-in applications.

18. The processing system of claim 13, wherein the first plug-in application is configured to model a software component of the storage system.

19. The processing system of claim 13, wherein the modeling data includes a modeling result.

20. The processing system of claim 13, wherein the modeling data includes a modeling parameter.

21. A processing system comprising:
a math library application programming interface (API) module configured to provide to a first plug-in application from a plurality of plug-in applications a schema of a set of a plurality of records, the plug-in application configured to store modeling data in the schema of the set of the plurality of records, each plug-in application being configured to model a component of a storage system that comprises processing systems and storage devices; and
a framework API module in communication with the math library API module, the framework API module configured to:
load the first plug-in application;
receive a request from the first plug-in application to store the schema with the modeling data; and
store the schema with the modeling data, the schema with the modeling data being accessible by a second plug-in application from the plurality of plug-in applications, wherein the first and second plug-in applications do not communicate directly with each other.
